(19) United States
(12) Patent Application Publication
(10) Pub. No.: US 2003/0200232 A1
(43) Pub. Date: Oct. 23, 2003

(54) Information processor and program

(75) Inventors: Hiroki Matsuoka, Chino-shi (JP); Chikara Nakayama, Minowa-machi (JP); Hirotaka Ogura, Nagano-shi (JP); Akihiko Saito, Nagano-shi (JP)

Correspondence Address: OLIFF & BERRIDGE, PLC, P.O. BOX 19928, ALEXANDRIA, VA, 22320, US

(73) Assignee: SEIKO EPSON CORPORATION., Tokyo (JP)

(21) Appl. No.: 10/385,645

(22) Filed: Mar. 12, 2003

(30) Foreign Application Priority Data
Mar. 13, 2002 (JP) 2002-069166

(51) Int. Cl. G06F 12/00

(52) U.S. Cl. 707/200

(57) ABSTRACT

The invention provides an information processor that allows a difference in the frequency of use among data storage regions to be reduced, thereby prolonging the useful life of the information recording device as a whole. An available data storage region in a flash memory is searched in a searching sequence recorded in a management table in a RAM, data is stored in the available data storage region thus detected, and the searching sequence recorded in the management table is updated.

### BACKGROUND OF THE INVENTION

1. Field of Invention

The present invention relates to information processors and programs, and more particularly, to an information processor and a program having enhanced management for information to be recorded in an information recording device.

2. Description of Related Art

According to a file management method of a related art information recording device, data is recorded as follows.

The recording region of an information recording device is divided into a plurality of data storage regions, which are referred to as clusters. Then, the clusters are managed using a file allocation table (hereinafter “FAT”). An available data storage region is searched by referring to cluster information in the FAT (a record of whether or not each data storage region is unavailable/available) in the ascending order of the numbers of directories, i.e., a list to manage the files according to the logical addresses. Then, data is stored in the available data storage region, and the directory structure and the FAT are updated.

FIG. 9 is a table of a related art directory structure. FIG. 10 is a table of a related art FAT. FIG. 11 is a flowchart of a related art process of storing data.

The directory structure shown in FIG. 9 contains data, such as file name, extension indicating the kind of OS that manages the file, attribute indicating the number of bytes and creation date, and FAT entry indicating where the data starts on the FAT. The FAT shown in FIG. 10 is recorded with cluster information indicating whether a data storage region is unavailable/available, and the subsequent cluster to that file, or whether the file ends at the point.

The FAT entry corresponding to a directory in FIG. 9 is referenced, and the cluster information in the FAT in FIG. 10 is then referenced. If the data storage region is available (i.e., when the cluster information=0), data is stored in the data storage region, and the status of the cluster in the FAT is rewritten from “available” (the cluster information=0) to “unavailable” (the cluster information=1). Then, the directory structure is rewritten. The rewriting of the directory structure means rewriting data, such as FAT entries (indicating FAT numbers) allocated to directory numbers, file name, extension.

If the data storage region is unavailable or occupied (the cluster information=1), the above process is repeated to the next directory. The process is sequentially carried out in the ascending order of directory numbers. Each directory number is fixed to a FAT entry.

### SUMMARY OF THE INVENTION

In the related art file management method described above, when a new file is produced, the search for an available data storage region is carried out in the ascending order of directory numbers. Since a directory number corresponds to a FAT number, data storage regions allocated to smaller directory numbers are more frequently used. The data storage region is worn every time data is rewritten therein, and as the wear progresses, the region can no longer allow data rewriting or reading. In an information storage, such as a EEPROM (Electrically Erasable and Programmable Read Only Memory), the number of rewriting is limited and small. Therefore, when data rewriting is frequently carried out in this storage, a problem of data destruction occurs.

Data storage regions with data that is not erased wear less quickly than those with data that is often erased. In other words, the wear progresses differently among the data storage regions, and a problem occurs such that some regions become unusable earlier than the other regions.

The present invention is an information processor and a program that can address or solve this problem in a relatively simple manner to reduce the difference in the use frequency among the data storage regions and can prolong the useful life of the information recording device as a whole.

In order to address or achieve the above, the invention provides an information processor with an information recording device having a plurality of data storage regions, and a management table to record the availability of each of the data storage regions in the information recording device. The information processor searches for an available data storage region in the information recording device in a searching sequence recorded in the management table, stores data in the available storage region detected by the searching, and updates the searching sequence recorded in the management table.

The searching sequence recorded in the management table is updated so that the data storage region to which data is stored last is at the end of the searched data storage regions in sequence.

In the invention, when a data storage region moving signal is input to an information processor with first information recording device and second information recording device third information recording device having a plurality of data storage regions, this processor stores data stored in the first information recording device to the second information recording device, stores data stored in the second information recording device to the third information recording device, so that the data arrangement in the first information recording device is changed.

In the invention, when a data storage region moving signal is input to an information processor with information recording device having a plurality of data storage regions, this processor 1) searches for an available data storage region in the information recording device, 2) moves first data, stored in a data storage region, to the available data storage region detected by the searching for storage, and 3) moves second data, stored in another data storage region to the region that had stored the first data, so that the data arrangement in the information recording device is changed.

The present invention also provides a program for use in an information processor that includes an information recording device having a plurality of data storage regions, and a management table to record the availability of each of the data storage regions in the information recording device. The program includes a program for searching for an available data storage region in the information recording device in a searching sequence recorded in the management table, a program for storing data in the available data storage region detected by the searching, and a program for updating the searching sequence recorded in the management table.

The searching sequence recorded in the management table is updated so that the data storage region to which data is stored last is at the end of the searched data storage regions in the sequence.

In accordance with the invention, when a data storage region moving signal is input to a program for use in an information processor that includes a first information recording device having a plurality of data storage regions, a second information recording device, and a third information recording device, this program includes a program for storing data stored in the first information recording device to the second information recording device, and a program for storing data stored in the third information recording device to the first information recording device, so that the data arrangement in the first information recording device is changed.

According to the invention, when a data storage region moving signal is input, a program for use in an information processor that includes an information recording device having a plurality of data storage regions, includes a program for searching for an available data storage region in the information recording device, a program for moving first data stored in a data storage region to the available data storage region detected by the searching for storage, and a program for moving second data stored in another data storage region to the region that had stored first data, so that the data arrangement in the information recording device is changed.

### BRIEF DESCRIPTION OF THE DRAWINGS

FIG. 1 is a schematic showing how data storage regions according to the invention are arranged;

FIG. 2 is a flowchart in accordance with an exemplary embodiment of the invention;

FIG. 3 is a chart that shows a directory structure according to the invention;

FIG. 4 is a chart that shows a FAT according to the invention;

FIG. 5 is a schematic of an information processor to which the invention is applied;

FIG. 6 is a schematic that shows the rotation of the data storage regions on a block-basis according to another exemplary embodiment of the invention;

FIG. 7 is a flowchart of the exemplary embodiment in FIG. 6;

FIG. 8 is a flowchart in accordance with another exemplary embodiment of the invention;

FIG. 9 is a chart in accordance with a related art directory structure;

FIG. 10 is a chart in accordance with a related art FAT;

FIG. 11 is a flowchart in accordance with a related art process of storing data.

### DETAILED DESCRIPTION OF PREFERRED EMBODIMENTS

An information processor and a program according to the invention are described below in detail in conjunction with the accompanying drawings.

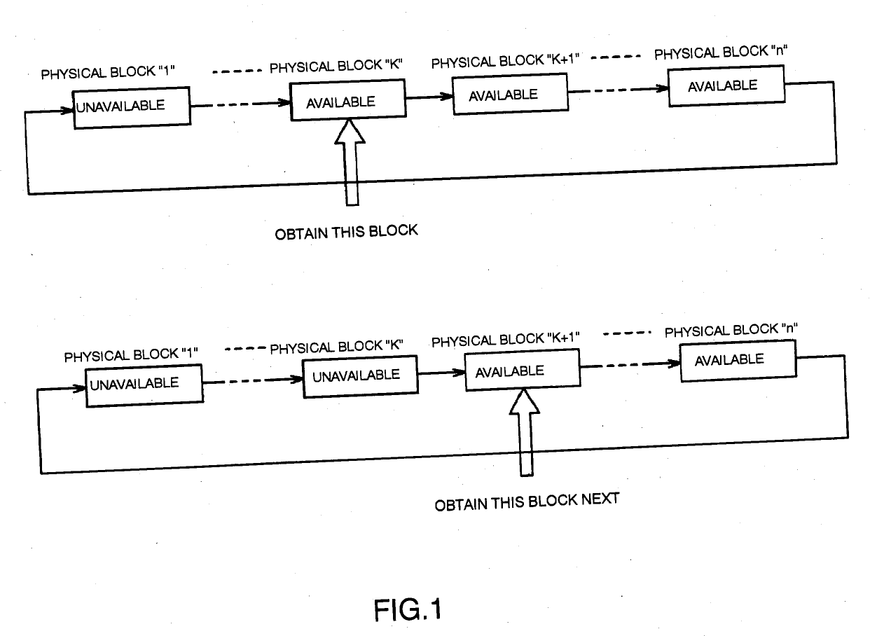

A first exemplary embodiment of the invention is described in conjunction with FIGS. 1 to 5.

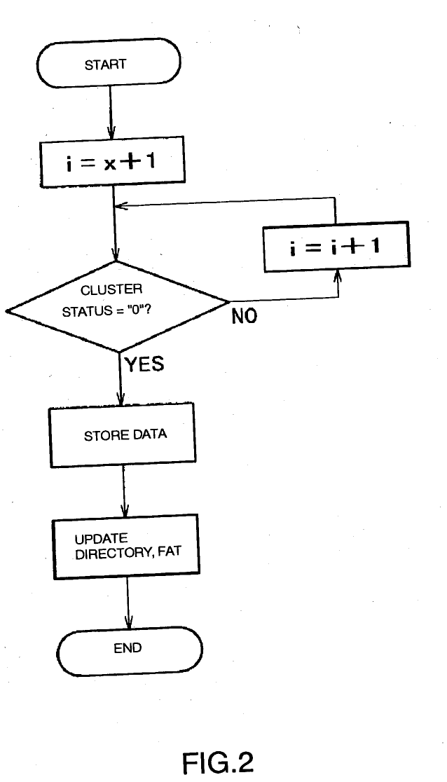

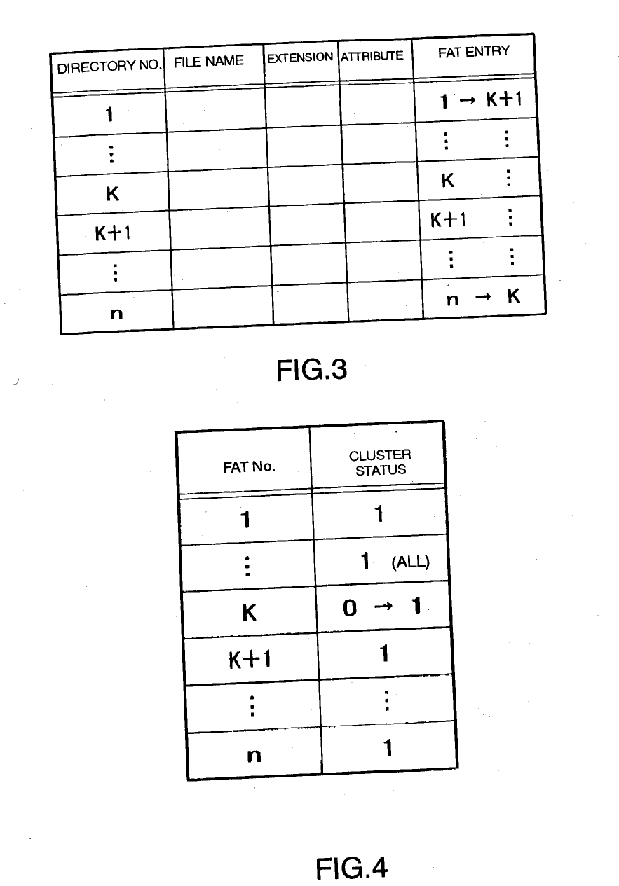

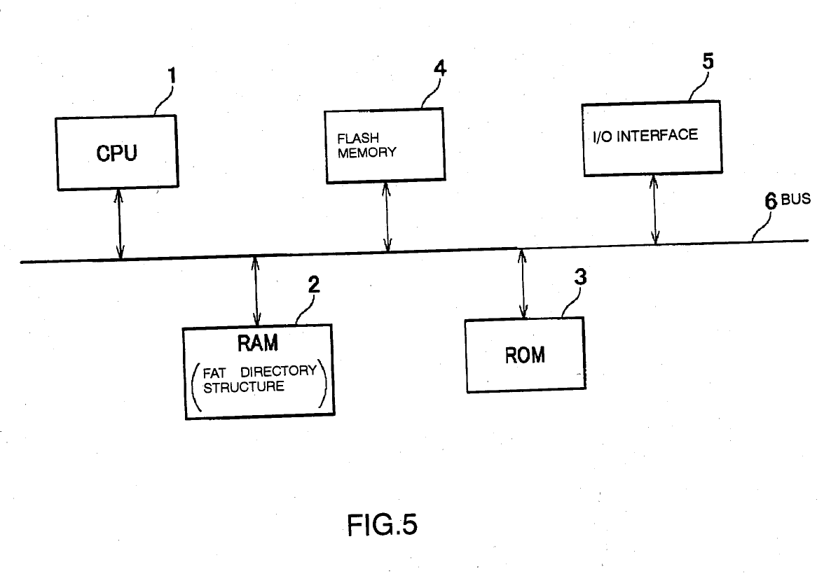

FIG. 1 is a schematic showing how data storage regions according to the exemplary embodiment are arranged, FIG. 2 is a flowchart for the exemplary embodiment, FIG. 3 is a chart that shows a directory structure according to the exemplary embodiment, FIG. 4 is a chart that shows a FAT according to the exemplary embodiment, and FIG. 5 is a schematic of an information processor to which the invention is applied.

FIG. 5 shows a CPU 1, a RAM 2, a ROM 3, a flash memory 4, an I/O interface 5, and a bus 6. A plurality of data storage regions are provided in the flash memory 4. The directory structure and the FAT are stored on the RAM 2, while a directory control program, and a FAT control program are stored on the ROM 3.

As shown in FIG. 1, physical blocks “1” to “n” are provided as the plurality of data storage regions, and data erasure or rewriting is carried out on a block-basis. In data writing, whether the physical block “1” is available or not is checked, and if the block is unavailable (occupied), the state of the physical block “2” is checked. Then, if the physical block “2” is unavailable, the state of the physical block “3” is checked, and the process goes on in this manner until an available block is detected. Data is written in the first available physical block “k” detected by searching. In the next data writing, searching for an available block starts from the physical block “k+1”.

The starting position of the searching sequence for an available physical block changes every time data is written, while the data storage regions form a chain, as shown in FIG. 1. In this arrangement, the starting position of the searching sequence for an available physical block can be rotated. Consequently, the frequency of writing to physical blocks with small numbers, which would otherwise be higher in the related art method, can be reduced. In this way, severe wear of the physical blocks with small numbers can be reduced, so that the useful life of the information recording device as a whole can be prolonged.

In the searching process, a cluster status indicating the availability of each physical block is provided in the FAT in advance, and the status is referenced to determine whether the physical block is available or not. More specifically, in FIG. 3, the FAT entry for the directory “1” is checked, and since the FAT entry is “1”, the cluster status of the FAT number “1” is referred to. Since the cluster status is “1” that indicates the block is unavailable, it is determined whether the physical block corresponding to the next directory (directory “2”) is unavailable/available.

The same process is repeated for the directory “3” and so on, and since the cluster status in the FAT corresponding to the directory “k” is “0”, it is determined that the physical block “k” is available. Then, data is written in the physical block “k”. In the FAT, the cluster status of the FAT number “k” is changed from “0” to “1”. The directory structure is rewritten as follows. The FAT entries are changed from upper to lower position, that is from “k+1”, “k+2”, . . . , “n”, . . . , “k”, and information, such as file name, extension and attribute, is rewritten corresponding to the FAT entries.

When data is written next, the FAT entry for the directory “1” is checked, and since the FAT entry is “k+1”, the cluster status of the FAT number “k+1” is referred to. The cluster status of this FAT number is “1” indicating that the block is unavailable, and it is therefore determined whether the physical block corresponding to the next directory (directory “2”) is available. The determination process is repeated for the directory “3” and so on, and if an available physical block is detected, the data is written in the available physical block.

In this manner, the block to start searching for availability is rotated, so that the frequency of writing to physical blocks with small numbers, which would otherwise be high in the related art method is reduced. Consequently, severe wear of the physical blocks with small numbers can be reduced, prolonging the useful life of the information recording device as a whole as described above. In addition to this feature, the sequence to search directories is not changed while the block to start searching for availability can be rotated, and therefore the useful life of the information recording device can be prolonged by simple file management.

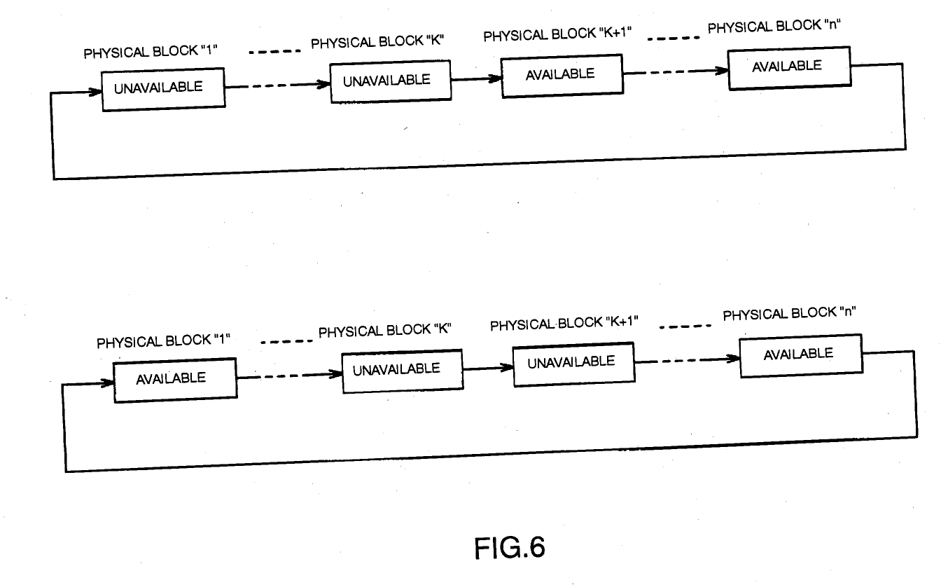

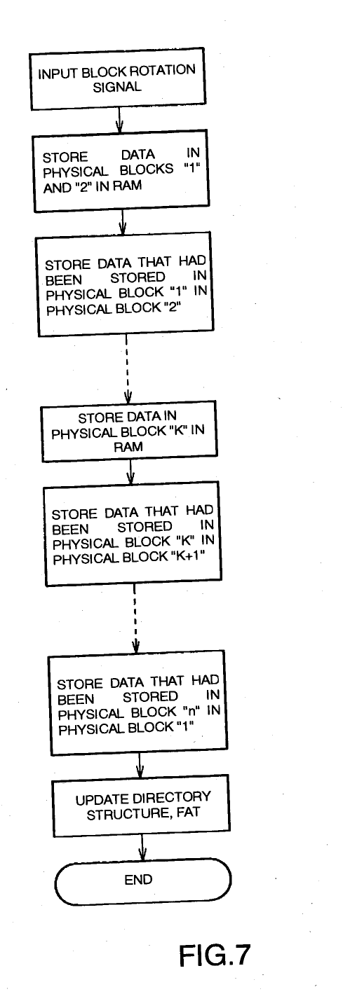

A second exemplary embodiment of the invention is described below in conjunction with FIGS. 6 and 7. FIG. 6 is a schematic illustrating the rotation of the data storage regions on a block-basis according to the exemplary embodiment. FIG. 7 is a flowchart of the exemplary embodiment.

Physical blocks “1” to “n” are provided as a plurality of data storage regions, and data erasure or rewriting is carried out on a block-basis. When a block rotation signal is input, data that has been stored in the physical blocks “1” and “2” is stored in the RAM 2. Then, data that had been stored in the block “1” is stored in the physical block “2”. Then, data in the physical block “3” is stored in the RAM 2, while the data that had been stored in the physical block “2” is stored in the physical block “3”.

Thereafter, data is sequentially updated in the same way as shown in FIG. 7, and when data that had been stored in the physical block “n” is stored in the physical block “1”, one cycle of data block rotation is complete. Along with the data block rotation, the directory structure and the FAT are updated. The directory structure and the FAT information may be updated entirely, but according to the exemplary embodiment, each FAT entry is incremented by 1, so that simple file management can be carried out.

When the next block rotation signal is input, the data block rotation the same as the above is carried out. The sequence of the data block rotation can be reversed, so that the FAT entry may be decremented by 1 after every rotation.

In this way, physical blocks having the data not to be erased, and those having the data to be often erased are exchanged in rotation, so that disparity in the wear state among the physical blocks is reduced, and it may take longer before unusable physical blocks occur. Therefore, the useful life of the information recording device can be prolonged. In addition, according to the exemplary embodiment, 1 is added for each FAT entry, and the FAT or the directory structure does not have to be entirely rewritten, so that the data block rotation is thus carried out by simple file management.

The user may output the block rotation signal in a desired timing, and therefore the timing can be set depending upon how the information recording device is used.

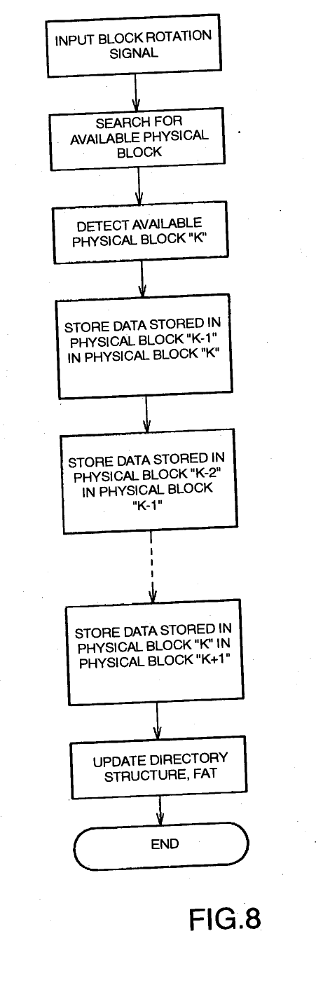

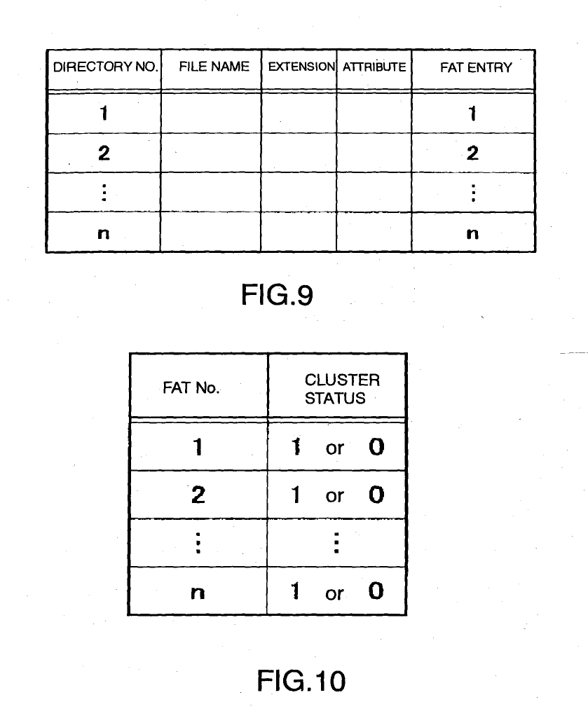

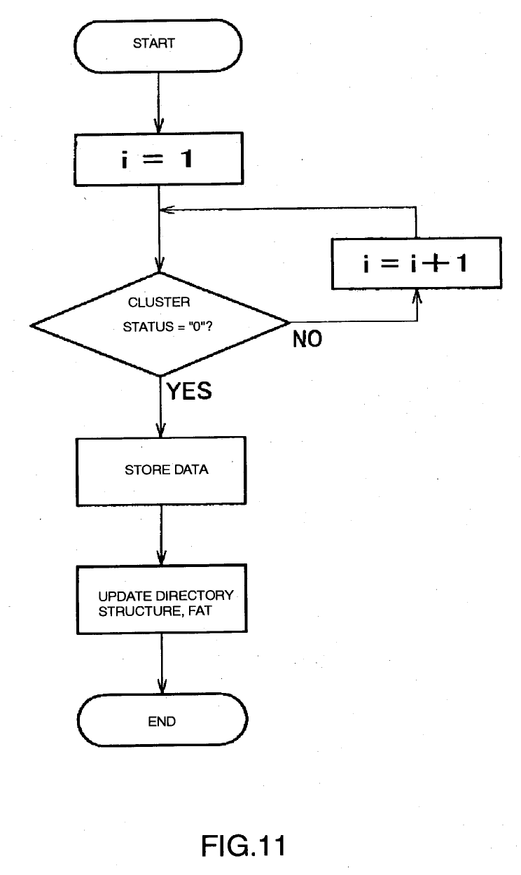

A third exemplary embodiment of the invention is described below in conjunction with FIG. 8. FIG. 8 is a flowchart for the exemplary embodiment.

Physical blocks “1” to “n” are provided as a plurality of data storage regions, and data erasure or rewriting is carried out on a block-basis. When a block rotation signal is input, an available physical block is searched for. When such an available physical block “k” is detected, data that has been stored in the physical block “k−1” is stored in the physical block “k”. Then, data that has been stored in the physical block “k−2” is stored in the physical block “k−1”. The same process is repeated thereafter, and the process is complete after a single data block rotation cycle.

According to the exemplary embodiment, the data that has been stored in the physical block “k” is stored in the physical block “k+1” in the end. Since this block is treated as being available, any kind of data may be stored. Along with the data block rotation, the directory structure and the FAT are updated. The directory structure and the FAT information may be updated entirely, but according to the exemplary embodiment, each FAT entry is incremented by 1, so that simple file management can be carried out. When the next block rotation signal is input, the block rotation the same as the above is carried out.

The sequence of the data block rotation can be reversed, so that the FAT entry may be decremented by 1 after every rotation.

However, when all the data storage regions are occupied, the data block rotation cannot be carried out.

Therefore, at least one of the data storage regions is left available.

According to the third exemplary embodiment, the data block rotation can be carried out without using an information storing device, such as a RAM to temporarily store data.

In this arrangement, physical blocks having the data not to be erased, and those having the data to be often erased are exchanged in rotation, so that disparity in the wear state among the physical blocks is reduced, and it may take longer before unusable physical blocks occur. Therefore, the useful life of the information recording device is prolonged. Also according to the exemplary embodiment, 1 is added for each FAT entry, so that the directory structure or the FAT does not have to be entirely rewritten, and the data block rotation is thus carried out by simple file management.

The user may output the block rotation signal in a desired timing, and therefore the timing can be set depending upon how the information recording device is used.

The arrangement according to the combination of the first and second exemplary embodiments or the first and third exemplary embodiments may be applied, so that the useful life of the information recording device may be prolonged even further.

The present invention may advantageously be applied to information recording devices that wear by data rewriting, such as EEPROM, flash memory, DVD-RAM, and hard disk.

As in the foregoing, the data storage regions in the information recording device wear every time data is rewritten, but according to the invention, the sequence of searching the data storage regions is changed, which reduces difference in the frequency of use among the data storage regions, and the useful life of the information recording device as a whole can be prolonged. When the frequency of rewriting is different among data, the data storage regions that store the data to be often rewritten could otherwise wear earlier, but the rotation of the data storage regions is carried out, so that the difference in the use frequency among the data storage regions is reduced, prolonging the useful life of the information recording device.

What is claimed is:

1. An information processor, comprising:
an information recording device having a plurality of data storage regions; and
a management table to record an availability of each of said data storage regions in said information recording device;
a device to search for an available data storage region in said information recording device in a searching sequence recorded in said management table;
a device to store data in said available storage region detected by said searching; and
a device to update the searching sequence recorded in said management table.

2. The information processor according to claim 1,
the searching sequence recorded in said management table being updated so that the data storage region to which data is stored last is at the end of the searched data storage regions in the sequence.

3. An information processor, comprising:
a first information recording device having a plurality of data storage regions;
a second information recording device having a plurality of data storage regions;
a third information recording device having a plurality of data storage regions; and
a device that, when a data storage region moving signal is input, stores data stored in said first information recording device to said second information recording device, and stores data stored in said second information recording device to said third information recording device, so that the data arrangement in said first information recording device is changed.

4. An information processor, comprising:
an information recording device having a plurality of data storage regions; and
a device that, when a data storage region moving signal is input, searches for an available data storage region in said information recording device, moves first data stored in a data storage region for storage in said available data storage region, and moves second data stored in another data storage region to the region that had stored said first data before the previous movement, so that the data arrangement in said information recording device is changed.

5. A program for use in an information processor that includes an information recording device having a plurality of data storage regions, and a management table to record an availability of said plurality of data storage regions in said information recording device, said program comprising:
a program for searching for an available data storage region in said information recording device in a searching sequence recorded in said management table;
a program for storing data in said available data storage region detected by the searching; and
a program for updating the searching sequence recorded in said management table.

6. The program according to claim 5,
the searching sequence recorded in said management table being updated so that the data storage region to which data is stored last is at the end of the searched data storage regions in the sequence.

7. A program for use in an information processor that includes a first information recording device, a second information recording device a third information recording device having a plurality of data storage regions, comprising:
a program for, when a data storage region moving signal is input, storing data stored in said first information recording device to said second information recording device; and
a program for storing data stored in said second information recording device to said third information recording device, so that the data arrangement in said first information recording device is changed.

8. A program for use in an information processor that includes an information recording device having a plurality of data storage regions, comprising:
a program for, when a data storage region moving signal is input, searching for an available data storage region in said information recording device;
a program for moving data first stored in a data storage region to said available data storage region detected by said searching for storage; and a program for moving second data stored in another data storage region to the region that had stored said first data, so that the data arrangement in said information recording device is changed.
